(19) United States
(12) Patent Application Publication
(10) Pub. No.: US 2026/0125145 A1
(43) Pub. Date: May 7, 2026

(54) MODULAR LINE ASSEMBLY FOR INSTALLATION IN AN AIRCRAFT FUSELAGE

(71) Applicant: Airbus Operations GmbH, HAMBURG (DE)

(72) Inventors: Carsten OHLFEST, HAMBURG (DE); Frank SCHNEIDER, HAMBURG (DE); Frederik ALBERS, HAMBURG (DE)

(21) Appl. No.: 19/117,830

(22) PCT Filed: Mar. 22, 2023
(86) PCT No.: PCT/EP2023/057271

§ 371 Date: Apr. 2, 2025

Related U.S. Application Data
(63) Continuation of application No. 17/973,832, filed on Oct. 26, 2022, now Pat. No. 11,878,785.

(30) Foreign Application Priority Data
Oct. 27, 2022 (EP) 22204135.2
Oct. 28, 2022 (CN) 202211334569.2

(51) Int. Cl. B64C 1/06; B64F 5/10; F16L 3/02; F16L 3/22

(52) U.S. Cl. CPC B64C 1/068; B64F 5/10; F16L 3/02; F16L 3/221

(57) ABSTRACT

A holding bracket for a line assembly in an aircraft fuselage. The bracket comprises a receiving space and a support portion. The support portion comprises a holding part at least partly surrounding the receiving space designed for receiving a line section of the assembly, and the holding part designed for holding the line section. The support portion also comprises a support part configured for fixedly attaching the holding part to a support. The holding part is attached to the support part via a movable attachment that is configured to provide a predetermined relative movement of the holding part in relation to the support part in an installed state of the line assembly.

### CROSS-REFERENCES TO RELATED APPLICATIONS

This application claims the benefit of International Application Number PCT/EP2023/057271 filed on May 2, 2024, 2022, the Chinese patent application No. 202211334569.2 filed on Oct. 28, 2022, the European patent application No. 22204135.2 filed Oct. 27, 2022 and the U.S. patent application Ser. No. 17/973,832 filed Oct. 26, 2022, the entire disclosures of which is incorporated herein by way of reference.

### FIELD OF THE INVENTION

The present invention relates to line installation in an aircraft, and relates in particular to a holding bracket for a line assembly in an aircraft fuselage, to a modular line assembly for installation in an aircraft fuselage, to an aircraft, to a method for installing a first line section and at least one second line section in a fuselage of an aircraft, and to a tool for mounting a holding bracket.

### BACKGROUND OF THE INVENTION

Commercial aircrafts usually have different equipment installed, e.g. for providing utility services such as lavatories to the passengers or for operating galleys by staff members for providing inflight passenger services. Different supply and discharge lines may be installed within the space enclosed by the fuselage. As an example, galley and sanitary equipment may require a potable water system for providing fresh water in a sufficient amount and quality. The potable water is commonly stored in a centralized water tank and is distributed via a pipe network. Such pipes may be provided as stainless steel or titanium pipes having a rather small diameter, e.g. between ½ inches (1.27 cm) and ¾ inches (1.905 cm). Further examples for high and low pressure potable water pipes are flexible hoses from plastic material, such as PEEK, wherein the high pressure hoses comprise an outer diameter of e.g. 0.6 cm. Furthermore, vacuum toilet systems may be installed, based on a pneumatic transport system, which serves for the hygienic disposal of human waste. For this, titanium pipes are provided, which may comprise a diameter of 2 inches (5.08 cm), to a central waste tank. Still further, a waste-water system may be installed, which is used to drain waste-water, e.g. from wash basins, via the heated drain masts overboard. EP 3 385 163 A1 and U.S. Pat. No. 10,822,774 B2, as examples, show an aircraft comprising a high-pressure water supply and distribution system. Furthermore, different types of lines may be installed in parallel, requiring a plurality of different brackets and mounting structures that need to be adapted to different requirements of the different types of lines. However, due to different expansion behavior, additional compensation sections may have to be installed, which has been shown to result in a mounting system with increased complexity also meaning unwanted weight and also increased costs.

### SUMMARY OF THE INVENTION

There may thus be a need for an improved installation for lines or similar system installations on board commercial aircraft to avoid at least some of the afore-mentioned constraints.

This need may be met is solved by one or more embodiments described herein. It should be noted that the following described aspects of the invention apply also for the holding bracket for a line assembly in an aircraft fuselage, for the modular line assembly for installation in an aircraft fuselage, for the aircraft, for the tool for mounting a holding bracket and for the method for installing a first line section and at least one second line section in a fuselage of an aircraft.

According to the present invention, a holding bracket for a line assembly in an aircraft fuselage is provided. The bracket comprises a receiving space and a support portion. The support portion comprises a holding part at least partly surrounding the receiving space designed for receiving a line section of the assembly. The holding part is designed for holding the line section. The support portion also comprises a support part configured for fixedly attaching the holding part to a support. The holding part is attached to the support part via a movable attachment that is configured to provide a predetermined relative movement of the holding part in relation to the support part in an installed state of the line assembly.

As an effect, it is possible to securely hold a line, i.e. a pipe, while still allowing movement caused by e.g. thermal or pressure induced expansion or even shrinking. The movable attachment provides the fixation to a structural part or another (non-or less moving) line or pipe on the one side, while providing a predetermined play or option for movement on the other side.

According to an example, the holding part of the support portion is adapted to glide and/or rotate in relation to the support part.

As an option, fixed and movable second line brackets may be used. When installing a bend in the second line section, the movable second line brackets may be rotated about an angle about the central axis of the first line section. The angle between the rotated second line bracket and the fixed second line brackets is larger than zero.

In an advantageous embodiment, the second support portion is adapted to glide and/or rotate on the first line section for compensating expansion and/or compression movements of the at least one second line section. In particular when the at least one bend is created, the second line brackets may be able to rotate about the local extension axis of the respective first line section. The respective bend may decrease in size when the second line section is compressed, while it may increase in size when the second line section expands. By letting the second support portion rotate about the respective first line section, this change in size is compensated. It is conceivable that the second support portion exerts only insignificant resistance to a relative movement to the first line section, so that compensation can always be performed.

For second line sections having a reduced flexibility, the support portions could be designed differently in order to avoid high structural stresses onto the support portions induced by the second line section. In a modified example, a bend is having a larger bending radius that is suitable for stiffer second line sections.

The bend is provided by deflecting one of the second line brackets by an angle around the first line section during installation. For example, the angle may be up to 45°. Still further, at least one of the other second line brackets may be fixedly attached to the first line section. It is conceivable that both other second line brackets, which are placed next to the movable second line bracket at opposite sides, are fixed.

It is further conceivable that the movable/rotatable second line bracket is able to pivot about a center line of the first line section. Also, it is conceivable that the range of rotation is limited to avoid jamming of the second line section upon excessive angles. To achieve this, for example, the rotation may be limited to angles of +/−30°. However, other limits, i.e. lower or greater limits, are possible.

In the event that the first line section stretches in the longitudinal direction, traction forces may arise in the second line section and on the fixed second line brackets, which causes the bend to decrease in size. This is achieved through a rotation of the respective second line bracket towards a smaller angle compared to the initial installation position. However, if the first line section is compressed in the longitudinal direction, the bend increases in size to compensate the increased overlength of the second line section. Thus, the second line bracket rotates to increased angles compared to the initial installation position.

The relative movement between the first line section and the second line section may be generated by various causes. For example due to a different thermal expansion coefficient between first line section and second line section due to the use of different materials; due to a flexible coupling in the first line section that allows to compensate deformations in the mechanical assembly of first line section and a structural part, in longitudinal and angular direction; due to different temperatures of and/or inside the first line section and the second line section; due to different pressure conditions in the first line section compared to the second line section, e.g. a negative pressure in the first line section and a positive pressure in the second line section.

The rotary movement in the second line bracket may be implemented between the respective second line bracket and the first line section or it may be provided as a part of the second support portion. Other directions of movement and rotation shall be blocked or released. It is clear that along the first line section several arrangements of fixed second line brackets and rotatable second line brackets are possible.

As an effect, the expected and wanted movement can be anticipated and allowed in a targeted manner, while providing restriction for unwanted movement.

According to an example, the support part is configured to be attached to a first line section, and the holding part is configured to receive a second line section being different than the first line section.

As an advantage, the second line can be hold by mounts in a distance pattern suitable for the second line section, while the first line section is attached e.g. to structural parts via mounts in a distance pattern defined by the available structural parts.

According to an example, the support part and the holding part are provided as separate parts that are releasably connectable with each other.

This allows a more efficient mounting procedure and also takes possible repair and maintenance into account.

According to an example, for an installation of the line, the holding part is fixable in relation to the support part in a predetermined installation position.

Such temporal fixation facilitates the installation procedure.

According to the present invention, also a modular line assembly for installation in an aircraft fuselage is provided. The assembly comprises a first line section, at least one second line section, a set of first line brackets and a set of second line brackets. The first line brackets comprise a first receiving space designed for holding the first line section and a first support portion for attaching the first line brackets to a structural part of the fuselage. The second line brackets comprise a second receiving space designed for holding the at least one second line section and a second support portion for attaching the second line brackets to a support. The set of the second line brackets comprises at least one holding bracket according to one of the preceding examples. The at least one second line section is attached to the first line section through a plurality of the second line brackets that are at least partly arranged at a distance to and are independent from the first line brackets.

As an effect, the use of the first line sections for holding the second line sections enables a modular pre-assembly of several parts, in this case different types of line sections, which can then be mounted as modules in the aircraft. The mounting and attachment of the second line can be optimized in terms of number and distance of the respective mounts. The movability provided by the mounts holding the second line sections allows for independent expansion or length reduction during operation and over time of the first line sections in relation to the second line sections.

According to an example, the at least one second line section comprises the same or higher flexibility than the first line section.

The separate mounts can be provided in the most appropriate manner due to the fact that the first line section is provide in a linear manner, contrary to structural parts, which are used for holding the first line sections, which structural parts like frames or stringers, are usually provided in a repetitive but distanced manner.

According to an example, the first line section comprises a vacuum pipe. The at least one second line section comprises at least one water hose.

Such combination is suitable for a lavatory's supply and discharge and allows a weight and space saving installation.

According to the present invention, also an aircraft is provided. The aircraft comprises a fuselage having at least one the group of a cargo space and a cabin space. The aircraft also comprises an installation arrangement in the fuselage. The installation arrangement comprises at least one modular line assembly according to one of the examples above.

According to the present invention, also a method for installing a first line section and at least one second line section in a fuselage of an aircraft is provided. The method comprises the following steps:
Attaching a first line section having a first diameter to a structural part of the fuselage through first line brackets, which comprise a first receiving space designed for holding the first line section and a first support portion for attaching the first line brackets to the structural part; and
Attaching at least one second line section having a second diameter to the first line section through second line brackets, which comprise a second receiving space designed for holding the at least one second line section and a second support portion for attaching the second line brackets to the first line section.

At least one second line section comprises a higher flexibility than the first line section. Further, the at least one second line section is attached to the first line section through a plurality of second line brackets that are arranged at a distance to and are independent from the first line brackets.

According to the present invention, also a tool is provided for mounting a holding bracket according to one of the examples above to a mounting surface having an at least part-circular mounting contour. The tool comprises a first interface for releasably engaging with a connection interface of the holding bracket. The tool also comprises a second interface for temporal engaging with a measuring device. In an engagement with the measuring device, the measuring device provides information about the angular relation of the holding bracket to the mounting surface.

According to an aspect, a mount for a line section is provided that allows movement in a predetermined and targeted manner, while still ensuring a safe mount. Such mount is in particular useful for holding a second line to a first line, e.g. a smaller line mounted to a larger line.

According to an aspect, the holding bracket provides a reliable but movable point of support for the respective line of the line assembly.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 schematically shows an example of a holding bracket for a line assembly in an aircraft fuselage.

FIG. 2 shows an example of a modular line assembly for installation in an aircraft fuselage.

FIG. 3 shows another example of a modular line assembly with a movable mount in an exploded view.

FIG. 4 shows the example of FIG. 3 in a mounted view.

FIG. 5 shows an example of a modular line assembly with a fixed mount in an exploded view.

FIG. 6 shows the example of FIG. 5 in a mounted view.

FIG. 7 shows another example of a modular line assembly in a top view.

FIG. 8a shows a further example of a modular line assembly in a side view.

FIG. 8b shows schematic cross section views along the modular line assembly of FIG. 8a.

FIG. 9 shows enlarged portions of the modular line assembly of FIG. 8a in an upper part and the respective cross sections of FIG. 8b in a lower part.

FIG. 10 shows a further example of a modular line assembly with second line sections mounted to first line sections and also to structural parts of the aircraft.

FIG. 11 shows a schematic top view of an aircraft comprising a line assembly.

FIG. 12 shows basic steps of an example of a method for installing a first line section and at least one second line section in a fuselage of an aircraft.

FIG. 13 shows a tool for mounting a holding bracket.

FIG. 14 shows the tool of FIG. 13 in the context of a modular line assembly during installation.

FIG. 15 shows another view of the tool of FIG. 14.

### DETAILED DESCRIPTION OF THE PREFERRED EMBODIMENTS

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the exemplary embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

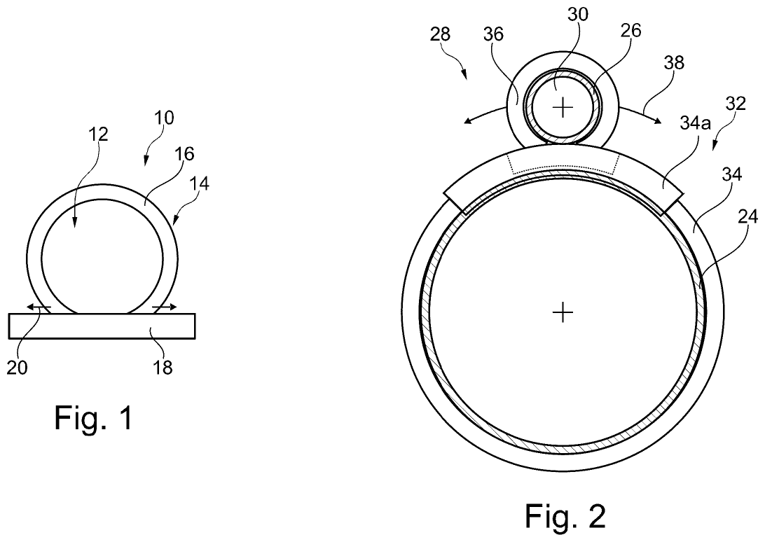

FIG. 1 schematically shows an example of a holding bracket 10 for a line assembly in an aircraft fuselage. The holding bracket comprises a receiving space 12 and a support portion 14. The support portion 14 comprises a holding part 16 at least partly surrounding the receiving space designed for receiving a line section of the assembly, and the holding part 16 designed for holding the line section. The support portion 14 also comprises a support part 18 configured for fixedly attaching the holding part 16 to a support. The holding part 16 is attached to the support part 18 via a movable attachment that is configured to provide a predetermined relative movement of the holding part 16 in relation to the support part 18 in an installed state of the line assembly. The movability is indicated in FIG. 1 with two arrows 20.

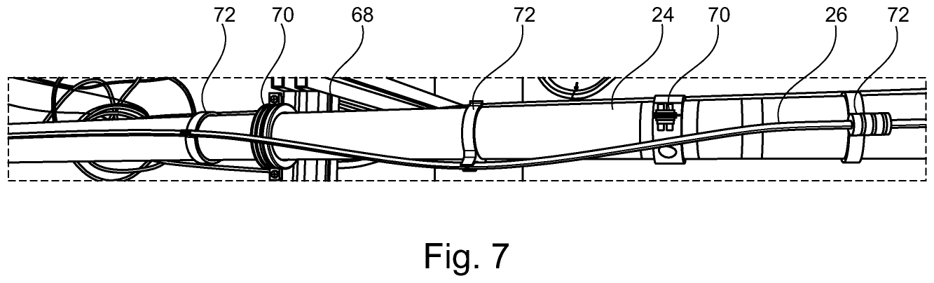

FIG. 2 shows an example of a modular line assembly 22 for installation in an aircraft fuselage in a cross-sectional view. The assembly 22 comprises a first line section 24 and at least one second line section 26. The assembly 22 also comprises a set of first line brackets (not shown in FIG. 2, but also see FIG. 7 ff.) and a set of second line brackets 28. The first line brackets comprise a first receiving space designed for holding the first line section 24 and a first support portion for attaching the first line brackets to a structural part of the fuselage. The second line brackets 28 comprise a second receiving space 30 designed for holding the at least one second line section 26 and a second support portion 32 for attaching the second line brackets to a support. The set of the second line brackets 28 comprises at least one example of the holding bracket 10 according to one of the preceding examples. The at least one second line section 26 is attached to the first line section 24 through a plurality of the second line brackets 28 that are at least partly arranged at a distance to and are independent from the first line brackets.

It is noted that FIG. 2 shows a cross-sectional view with only one second line section 24 and also one second line bracket 28. It is further noted that more second line sections 24 can also be provided, and also more second line brackets 28, as for example shown in FIG. 7.

As an example, the second support portion 32 of the second line brackets 28 comprises a ring-like sleeve 34 being mounted onto the first line section 24. The ring-like sleeve 34 comprises a widened section 34a configured for a sliding hold of a holding section 36 forming the second receiving space 30. The holding section 36 can move in relation to the second support section 32. The movement is indicated with arrows 38.

In an example, the set of the second line brackets comprises a plurality of holding brackets according to one of the preceding examples.

In another example, another set of the second line brackets is provided as non-movable holding brackets, i.e. as brackets that fixedly secure some parts of the at least one second line section. For example, the holding part and the support part are fixedly connected, i.e. non-movable, e.g. by forming them in an integrated manner. In a further example, the holding part is directly mounted to a base or support, e.g. to a structural part or the first line section. The first receiving space is designed for receiving and holding the first line section.

The term “holding bracket” relates to a device arranged for holding a line, such as a supply line, in a line assembly in the aircraft.

The term “holding part” relates to a part of the bracket that is provided for actually holding the line section.

The term “support part” relates to a part of the bracket that is provided for mounting of the bracket, e.g. to a structural support or another line.

The term “attached” relates to the holding part being connected or mounted to the support part.

The term “movable attachment” relates to holding the holding part such that a relative movement is still possible.

The term “predetermined relative movement” relates to a movement between two defined outer positions, e.g. a movement between two abutment or stop portions along a defined movement path.

The term “installed state” relates to a state when the holding brackets and the line assembly are installed and in use.

Providing the predetermined relative movement allows to compensate relative motion of the line such as caused by pressure differences inside the line or due to temperature variations or due to external loads or due to installation tolerance or due to flight movement.

The term “line” refers to lines for transporting a media, such as a fluid like gas or liquid or a mixture thereof. The term line can also be referred to as duct or conduit or pipe. An example are lines for supplying and discharging liquids like water. Another example are vacuum pipes, e.g. for discharging waste and wastewater from lavatories. Another example are conduits for supplying fuel like kerosine, hydrogen and others. A still further example are oxygen ducts.

An example for the removable fixation element is a removable pin (see e.g. FIG. 4).

Another example for the removable fixation element is an externally applied clamping or fastening element.

As an option, the removable fixation element is provided to be reusable, e.g. for maintenance and repair purposes.

An example for the removable fixation element is a predetermined breaking point between the holding part and the support part. In an example, the breaking point is configured to break during one of the first operation cycles.

In an example, all second brackets for the second line are provided as the same basic bracket with a fixation element, but after assembly and mounting, the fixation element is removed in a part of the second brackets, providing a movable hold. While the fixation element remains, i.e. is not removed, in the other part of the second brackets, providing a secure rigid hold.

In an example, not further shown in detail, the second support portion is adapted to move in relation to the first line section for compensating expansion and/or compression movements of the at least one second line section.

In an example, the second support portion is adapted to move in relation to the first line section for compensating expansion and/or compression movements of the at least one second line section in relation to the first line section.

For example, the relative movement is provided to compensate an expansion movement of the first line section, while the at least one second line section shows less expansion movement.

For example, the relative movement is provided to compensate a compression movement of the first line section, while the at least one second line section shows less compression movement.

In an example, the second support portion is adapted to glide and/or rotate on the first line section for compensating expansion and/or compression movements of the at least one second line section.

In an example, the second support portion is adapted to glide and/or rotate in relation to the first line section for compensating expansion and/or compression movements of the at least one second line section.

In an example, the first line section is having a first diameter and the at least one second line section is having a second diameter.

As an example, the first diameter is larger than the second diameter.

As another example, the first diameter is smaller than the second diameter. As a further example, the first diameter and the second diameter are similar or even equal.

In an example, not further shown in detail, the second support portion is configured for attaching the second line brackets to the first line section.

In an option, a part of the second line brackets is configured for attaching the second line brackets to the first line section and another part of the second line brackets is configured for attaching the second line brackets to a support structure.

In an option, the second support portion is adapted to glide and/or rotate on the first line section for compensating expansion and/or compression movements of the at least one second line section.

In an example, the holding part is slidable in a circumferential manner in relation to the support part.

In an example, the support part provides a receiving space for a movable engaging with a connecting portion of the holding part. For example, the receiving space is a groove in which the connecting portion engages in a sliding manner.

In an example, the support portion delimits a circular groove around a part of the first line section. The holding part is provided as a part-circular clamp partly enclosing the first line section in a circumferential manner. In an example, the support portion is provided as two cable binders or other circumferential line clamps delimiting the space between forming the groove.

In another example, the support portion is provided as one cable binder or other circumferential line clamp delimiting the space between forming an abutting ring-form structure.

In a further example, a clamp with a screw as a locking means or other fixation e.g. snap-in is provided.

In another example, the holding part is rotatable in a quasi-circumferential manner in relation to the support part.

In another example, the holding part is a pin acting as a swivel axis.

In another example, the holding part is connected to the support part by a flexible connection portion allowing a swivel motion.

In an example, not further shown in detail, the second support portion is configured for attaching the second line brackets to a support structure.

In an example, a movable support is thus provided also in places where a structural part is available for mounting the second line section.

In an example, not further shown in detail, the at least one second line section comprises the same or higher flexibility than the first line section.

In an example, the first line section is substantially rigid.

In a first variation, a modular line assembly for installation in an aircraft fuselage is provided. The assembly comprises a first line section; at least one second line section; a set of first line brackets; and a set of second line brackets. The first line brackets comprise a first receiving space designed for holding the first line section and a first support portion for attaching the first line brackets to a structural part of the fuselage. The second line brackets comprise a second receiving space designed for holding the at least one second line section and a second support portion for attaching the second line brackets to the first line section. The at least one second line section is attached to the first line section through a plurality of second line brackets that are arranged at a distance to and are independent from the first line brackets.

In an example, the first line section has a first diameter. In another example, the at least one second line section has a second diameter.

In an example, the at least one second line section comprises the same or higher flexibility than the first line section.

In an option of the first variation, the second support portion is adapted to glide and/or rotate on the first line section for compensating expansion and/or compression movements of the at least one second line section.

In a second variation, a modular line assembly for installation in an aircraft fuselage is provided. The assembly comprises a first line section having a first diameter; at least one second line section having a second diameter; a set of first line brackets; and a set of second line brackets. The first line brackets comprise a first receiving space designed for holding the first line section and a first support portion for attaching the first line brackets to a structural part of the fuselage. The second line brackets comprise a second receiving space designed for holding the at least one second line section and a second support portion for attaching the second line brackets to the first line section. At least one second line section comprises the same or higher flexibility than the first line section. The at least one second line section is attached to the first line section through a plurality of second line brackets that are arranged at a distance to and are independent from the first line brackets.

In an option of the second variation, the second support portion is adapted to glide and/or rotate on the first line section for compensating expansion and/or compression movements of the at least one second line section.

In an example, at least one second line bracket is arranged between two consecutive first line brackets.

In an example, not further shown in detail, the at least one second line section comprises at least one bend in an overlapping region with one of the first line brackets and/or another component.

In an example, the first diameter exceeds the second diameter.

In an example, the second line brackets comprise a clamp that encloses the first line section in a plier-like manner.

In an example, the second line brackets comprise a stiction layer in direct contact with a surface of the first line section.

In an example, the second line brackets are designed for holding a plurality of second line sections.

In an example, the second line brackets comprise at least one snap-in connector for holding the at least one second line section.

In an example, the second receiving space and the second support portion are provided in a base component and a top component. Further, the base component and the top component are connectable to each other through a releasable connector.

In an example, the support part and the holding part are provided as a base component and a top component. The base component and the top component are connectable to each other through a releasable connector.

In an example, for an installation of the line, the holding part is fixable in relation to the support part in a predetermined installation position, such as by the pin 50 shown in FIG. 4.

In an example, a removable fixation element is provided that blocks a relative movement of the holding part in relation to the support part and vice versa. Upon removing the fixation element, the holding part and the support part can be moved in relation to each other.

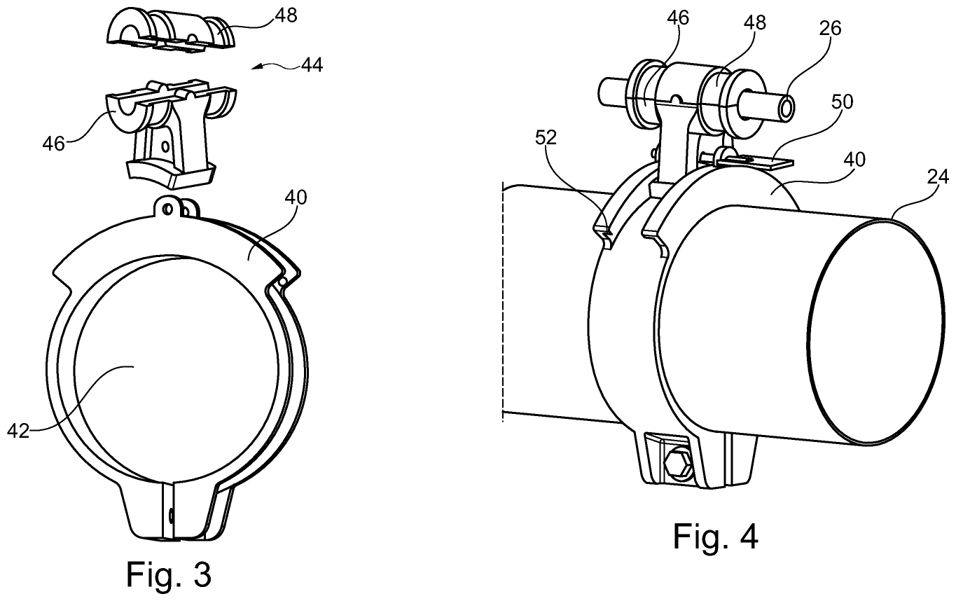

FIG. 3 shows another example of the modular line assembly 22 with a movable mount in an exploded view. The second support portion 32 comprises a base part 40 enclosing a space 42 for receiving the first line section 24. The second support portion 32 also comprises a top part 44 enclosing the second receiving space 30. The top part 44 comprises a first portion 46 forming the structural part and a second portion 48 forming a cover part for holding the second line section 26 (see FIG. 4).

The connection part of the top part 44, i.e. in FIG. 3 the lower part is formed like a foot with a broader plate shaped in a curved manner adapted to the contour of the guiding portion of the base part 40. In an option, lateral grooves are provided in the side wall portion of the base part 40 delimiting the guiding portion, for slidably guiding and holding the top part 44.

FIG. 4 shows the example of FIG. 3 in a mounted view. For an installation, a temporal fixation means 50 like a removable pin inserted in matching recesses or holes is provided. Further, end stops 52 are provided for limiting the possible sliding movement of the top part 44 in relation to the base part 40.

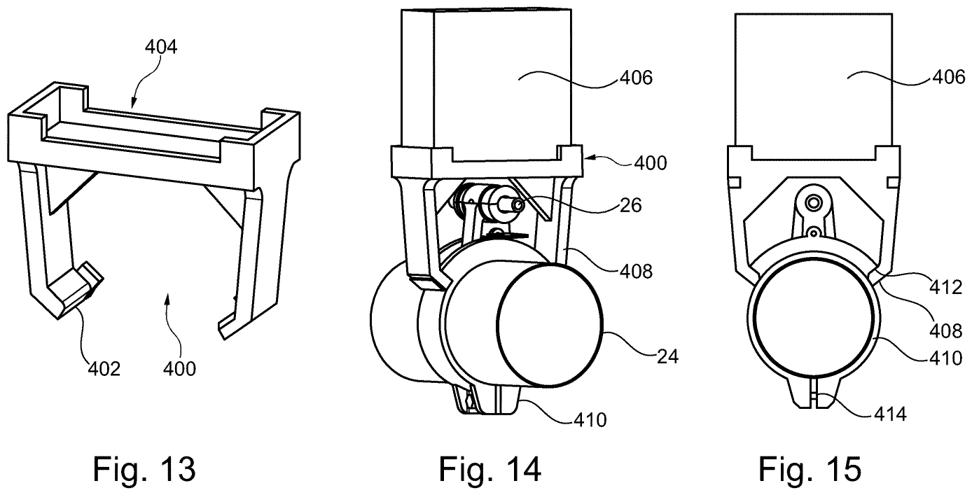

In an option, the outer contour of the lateral portions providing the end stops are provided as an interface with a mounting tool (see also FIGS. 13-15).

The pin can be pulled out once the mount with the second line section 26 is installed in the correct angular position defining the center of the range of movement during operation.

In an option, instead of a sliding movement as shown in FIG. 4, a pivoting mount of the upper part to the lower part is provided allowing a rotational or pivoting movement of the mount of the second line section.

In an example, as shown in FIG. 4, the holding part of the support portion is adapted to glide and/or rotate in relation to the support part.

In an example, not further shown in detail, the support part is configured to be attached to a first line section 24, and the holding part is configured to receive an example of the second line section 26 being different than the first line section 24.

The first line section can be referred to as primary line section, and the second line section can be referred to as secondary line section.

In an example, the support part is configured to be attached to a support structure, such as structural parts of a fuselage or support brackets for mounting installation and equipment.

In an example, as shown as option in FIG. 3 and FIG. 4, the support part and the holding part are provided as separate parts that are releasably connectable with each other.

In an example, the support part and the holding part are connectable to each other through a releasable connector.

In an example, as shown in FIG. 4, the first line section 24 comprises a vacuum pipe. The at least one second line section 26 comprises at least one water hose.

In an example, at least one of the at least one second line bracket allows a relative motion of the second line section along a main extension direction of the second line section.

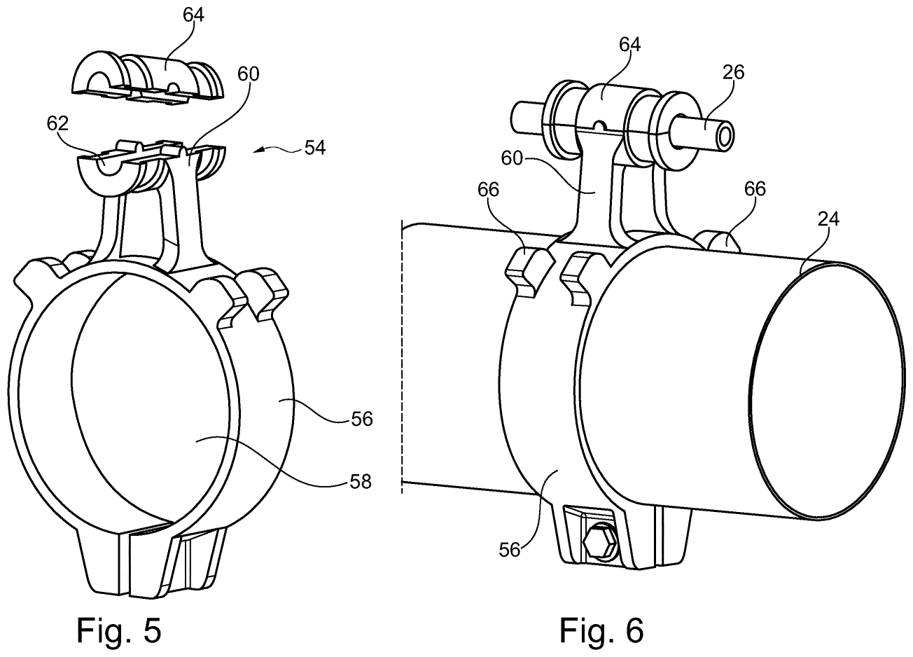

FIG. 5 shows an example of a modular line assembly with a fixed mount 54 for a second line section 24 in an exploded view. A base portion 56 encloses a space 58 for receiving the first line section 24. An upper portion 60 provides a space 62 for receiving the second line section 26. A cover part 64 is detachable for arranging and then clamping or holding the second line section 26.

FIG. 6 shows the example of FIG. 5 in a mounted view with the second line section 26 being hold in a fixed manner.

As an option, abutment portions 66 are provided as an interface with the mounting tool (see also FIGS. 13-15).

The fixed mounts of FIG. 5 and FIG. 6 can be arranged along the line section in a combined or mixed manner with the movable mounts of FIG. 3 and FIG. 4.

FIG. 7 shows another example of a modular line assembly in a top view. A first line section 24 is provided that is mounted to a base structure 68 with first line brackets 70. Further, a second line section 26 is mounted to the first line section 24 with second line brackets 72. At least some of the second line brackets 72 are provided as the example of FIG. 3 and FIG. 4 providing a movable mount. As indicated, the second line section 26 can thus deform during operation, such as forming a bend, while the holding brackets allow such movement.

Such bend is indicated in the middle portion. Due to the circumferentially sliding mount of the second line section 26, the bend of the second line section is arranged close to the first line section 24 resulting in a compact and thus less space absorbing manner. The second line's slack is thus provided in a spatially controlled manner. Should the second line section 26 expand further, the bend could be increased. In case of less length difference, the bend could easily be decreased. During the change in the length difference, a secure hold of the second line section is provided. The line's slack is thus controlled.

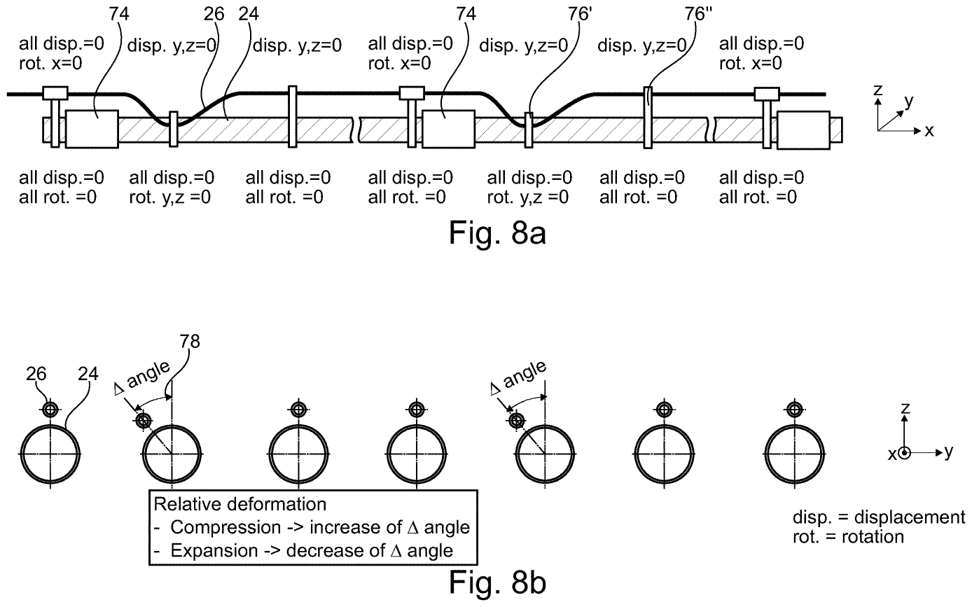

FIG. 8a shows a further example of a modular line assembly in a side view comprising the first line section 24 and the second line section 26. FIG. 8b shows schematic cross section views along the modular line assembly of FIG. 8a.

As shown, the first line section 24 is mounted via a plurality of first line brackets 74. The second line section 26 is mounted via a plurality of second line brackets 76. Some of the second line brackets 76 are provided as movably mounting second line brackets 76′, while others are provided as non-movable second line brackets 76″. The movably mounting second line brackets 76′allow forming a bent, e.g. for length differences compensation. The bend can form in circumferential direction, as indicted in the cross sections below in FIG. 8b, and also shown as angle 78.

In FIG. 8a and FIG. 8b, a coordinate reference with axis x, y and z is indicated, for example relating or representing an aircraft's scheme of spatial axis. Further, values of displacement (“disp.”) and rotation (“rot.”) around the first line's longitudinal axis are indicated.

In an option, the second line section is arranged above the first line section when installed. In another option, the second line section is arranged on a lateral side of the first line section. In a further option, the position is selected as desired and may change depending on the available space. In a still further option, the position of the second line section in relation to the first line section changes along the extension of the line sections.

The movable mounts of the second line sections allow relative deformation of the second line sections. For example, in case of compression, the angle (of rotation) increases and decreases in case of expansion.

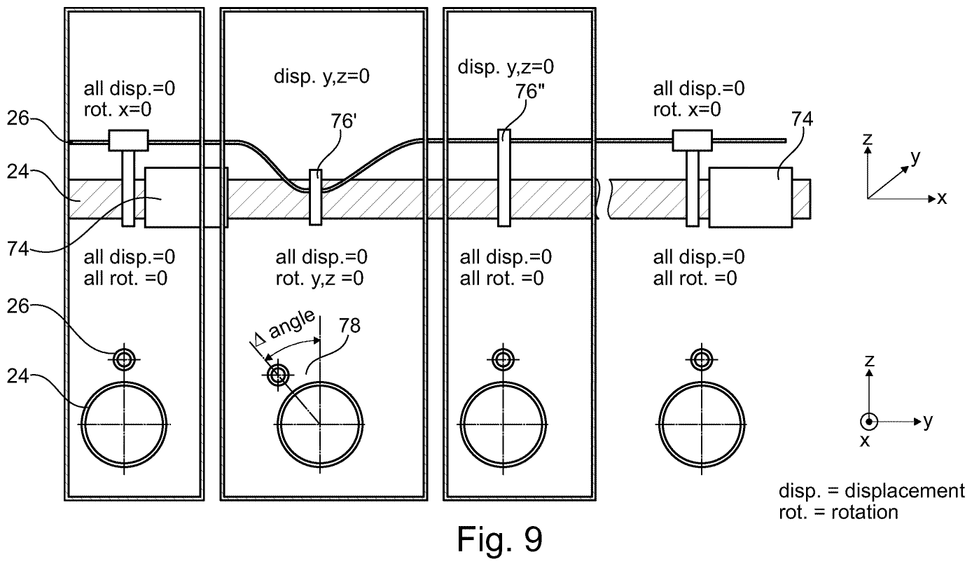

FIG. 9 shows enlarged portions of the modular line assembly of FIG. 8a and in an upper part and the respective cross sections of FIG. 8b in a lower part.

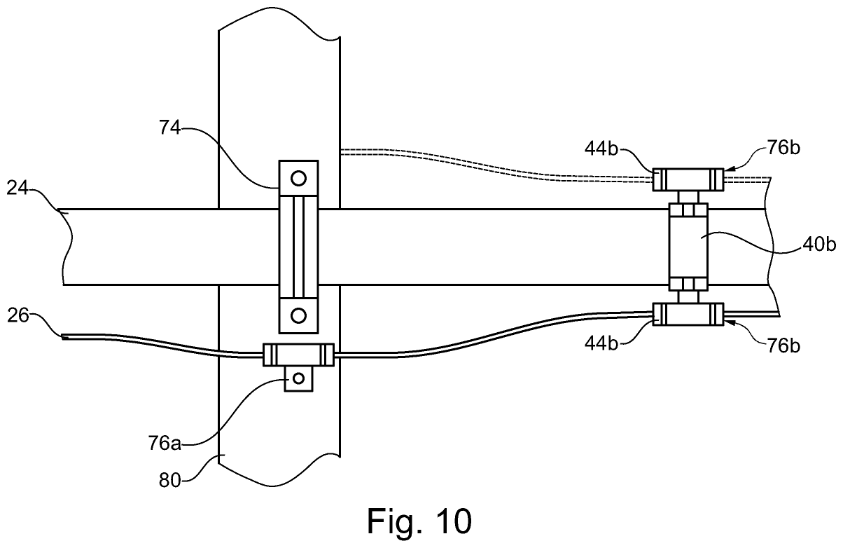

FIG. 10 shows a further example of a modular line assembly with second line sections 26 mounted to first line sections 24 and also to structural parts 80 of the aircraft with second line brackets 76a designed for being mounted to the structural part, while still allowing the relative movement of the second line section. Such mounting may be applied where structural parts are available in a matching manner regarding the optimized distance for mounting and holding the second line sections.

As an option, also two or even more second line brackets 76b can be provided on the first line section 24. For example, several upper parts 44b can be hold by a common base part 40b.

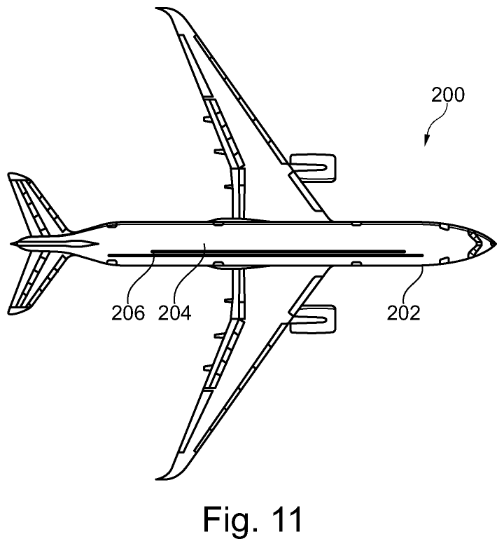

FIG. 11 shows a schematic top view of an aircraft 200 comprising a fuselage 202 having at least one the group of a cargo space and a cabin space 204. Further, an installation arrangement 206 is provided in the fuselage. The installation arrangement comprises at least one example of the modular line assembly 22 according to one of the preceding examples.

In an example, the aircraft that comprises a fuselage having an interior space, and at least one modular line assembly according to one of the preceding examples.

As advantage, the holding bracket allows defined formation of a bend in the second line section in circumferential direction of the first line section. As advantage, the holding bracket allows movements into the bracket instead of movements between bracket and first line section. As advantage, the holding bracket allows simplified installation due to the possibility to temporarily lock the movable behavior. As advantage, the holding bracket allows a reduced space envelope due to defined movements of the second line section around the first line section (neutral position for installation, minimum and maximum deflection). As advantage, the holding bracket provides means for industrialization of the concept of a modular line assembly. As advantage, the holding bracket allows reduction in the number of required interface brackets in a modular line assembly, e.g. assumed the combined fixed bracket for first and second line is used.

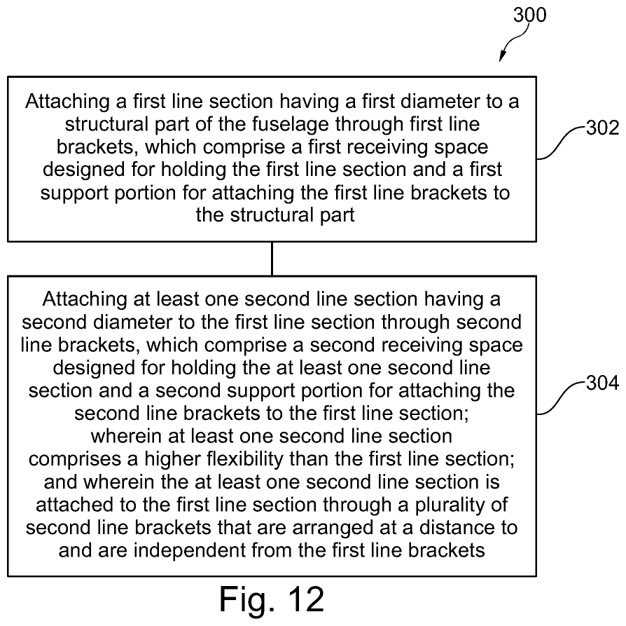

FIG. 12 shows basic steps of an example of a method 300 for installing a first line section and at least one second line section in a fuselage of an aircraft. The method 300 comprises the following steps:
Attaching 302 a first line section having a first diameter to a structural part of the fuselage through first line brackets, which comprise a first receiving space designed for holding the first line section and a first support portion for attaching the first line brackets to the structural part; and
Attaching 304 at least one second line section having a second diameter to the first line section through second line brackets, which comprise a second receiving space designed for holding the at least one second line section and a second support portion for attaching the second line brackets to the first line section.

At least one second line section comprises a higher flexibility than the first line section. Further, the at least one second line section is attached to the first line section through a plurality of second line brackets that are arranged at a distance to and are independent from the first line brackets.

In an example of the method, the second line is mounted with a base bend, i.e. base deviation from a straight line to ensure that tensile forces acting on the line can be compensated for by the movable hold of the brackets.

In an example of the method, the second line brackets allow an installation of the line in a pre-defined mounting position.

FIG. 13 shows a tool 400 for mounting a holding bracket according to one of the examples above to a mounting surface having an at least part-circular mounting contour. The tool 400 comprises a first interface 402 for releasably engaging with a connection interface of the holding bracket, and a second interface 404 for temporal engaging with a measuring device 406 (see FIG. 14). In an engagement with the measuring device 406, the measuring device 406 provides information about the angular relation of the holding bracket to the mounting surface.

FIG. 14 shows the tool of FIG. 13 in the context of a modular line assembly during installation. The first interface 402 of the tool 400 comprises two arms 408 with end contacting surfaces for engaging or abutting against a mounting bracket 410. The mounting bracket 410 comprises matching stops or engagement protrusions 412.

FIG. 15 shows another view of the tool of FIG. 14. By rotating the tool 400 around the first line section 24, the bracket 410 can be rotated in a facilitated way to achieve proper adjustment of the bracket 410. Once aligned, screws 414 can be tightened.

The tool 400 is suitable for adjusting the bracket in its angular position during installation for achieving the desired centered position. The tool allows the rotation of the bracket when placed on the round base, e.g. in form of the first line section, before the base part of the bracket is fixed in its angular position.

The tool 400 for mounting can also be referred to as mounting tool. The measuring device 406 is preferably a leveling device, such as a water level. In an option, also a distance sensing device is provided.

In an option, a method for mounting comprises the application of an example of the tool 400 for mounting providing a measuring of the relative rotational position of the second line brackets.

In an example, the tool 400 is also provided with a data interface for providing the measured data to a documentary unit.

In an example, the tool 400 is provided with two clamping arms that are configured for engaging with two protrusions of the holding bracket. The two clamping arms are also configured to allow a rotational alignment of the holding bracket when provided on, i.e. engaging with, the line to which it is mounted.

In an option, the mounting tool 400 is configured to align the first line brackets.

In an example, the measuring device, in particular the level device, is fixedly engaging with the second interface.

An advantage is achieved by implementing the above design concept for a new bracket family for modular line assemblies in combination with a method for installation which is tailored for bends in the second line section oriented in circumferential direction. According to an aspect, the mechanical bearing between the second line section and the first line section is provided such that it enables the controlled deformation of the second line section in a bend. This bend is required e.g. to compensate for length differences. The relative movement between the first line section and the second line section can be generated by various causes, for example due to different thermal expansion coefficient between first line section and second line section, e.g. different material characteristic, flexible coupling in the first line section that can compensate for deformations in longitudinal and angular direction, different temperatures of the first line section and second line section, different pressure conditions in the first line section compared to the second line section, e.g. negative pressure in the first line section which tends to a push in effect for any flexible elements while there is a positive pressure in the second line section which causes the opposite effect for any flexible elements or the second line section itself, and different external mechanical loads introduced into the first line section or second line section. The described product family comprises the new brackets. In an example, a bracket is provided with an integrated rotation mechanism. To setup the circumferential bend, one or more of the interface bracket clips are deflected by an angle delta during installation, for example 45°. Further, there are brackets which serve as fixed bearings on the left and right end of the one or more deflectable brackets. The brackets, which are pre-installed with a delta angle, allow a certain rotational movement after installation. The range of rotation is limited via end stops, for example to angles of +/−30°. In the event that the first line section stretches in the longitudinal direction, a traction force arises between the two fixed bearings in the second line section. This causes the movable brackets to rotate towards an angle with a smaller deflection compared to the initial installation position. In the event that the first line section compresses in the longitudinal direction, a compressive force arises between the two fixed bearings in the second line section. This causes the bracket to rotate towards an angle with a greater deflection compared to the initial installation position. In an option, the rotational movement is (in addition or alternatively) realized in an interface between the first line section and the bracket while the bracket itself is designed rigid. In an option, the bracket comprises a base module and a top module and forms the movable interface between the first line assembly and the second line assembly. The base module is fixed to the first line section, e.g. all rotations and displacements are blocked, and the top module is fixed to the second line section, e.g. rotation around longitudinal axis is free, displacement in longitudinal direction is free all other degrees of freedom are blocked. A kinematic or an elastic element is integrated into the bracket between the top module and the base module. This allows movements in circumferential direction of the second line section around the first line section. Further the kinematic or the elastic element comprises an element to block the movement partially to ease installation at a defined position. End stops control the movements of the top module relative to the base module and limit the area of deflection. An exemplary design for such a bracket provides the rotational movement via a sliding mechanism between base module and top module. At each end of the sliding mechanism end stops are located to limit the maximum and minimum deflection. Means for blocking the rotational movement via a splint pin in a neutral position are provided.

In an option, a combined bracket for first and second line assembly is provided. This concept merges the design of a first line bracket with the possibility to serve as a second line bracket as well. For example, a so-called omega clamp used to install a vacuum duct to the aircraft structure is equipped with an additional means to install a water hose. This additional support means to install a second line section to a first line bracket can be permanently or detachably connected. This reduces the number of required brackets.

In an option, mechanical bearings are provided between bracket and first line section on the one hand and bracket and second line section on the other hand that can be conceived for the new brackets introduced above.

In a first variation, fixed-fixed brackets are provided:
Fixed connection between first line section and second line section via a bracket. This variation provides zero degrees of freedom of movement, e.g. regarding the mounted second line section.

In a second variation, fixed-movable brackets are provided:
Fixed connection between bracket and first line section. This provides zero degrees of freedom of movement, e.g. regarding the mount to the first line section.
Second line section is secured against movement in y and z direction but can move in x direction. This variation provides one degree of freedom of movement, e.g. regarding the mounted second line section.

In a third variation, Fixed-rotatable brackets are provided:—Fixed connection between bracket and first line section. This provides zero degrees of freedom of movement, e.g. regarding the mount to the first line section.—Longitudinal and rotational movement of second line section in bracket is free, all other degrees of freedom are blocked. This provides two degrees of freedom of movement, e.g. regarding the mounted second line section.—The bracket has an included rotation mechanism so that the second line section can rotate around the first line section. This provides one degree of freedom of movement, e.g. regarding the mounted second line section.—The rotation mechanism can be locked or unlocked.

In an option, it is not necessary that all brackets are installed directly on top of the first line section. Rather, it is also conceivable to attach some of the brackets to structural elements. In areas without any structures available, the brackets can be installed to the first line section, for example in the middle of a frame bay.

According to another aspect, also a tool for positioning the brackets on a first line section or in general in relation to structural elements is provided. This tool has an interface to the bracket. Bracket and tool are designed in such a way that the combination is only possible in one defined way. Therefore a special interface element between the tool and the bracket is designed. This concept can be used for all members of the new bracket family. It includes the following functions: The measuring device can be a digital protractor to adjust the rotation of the brackets which is installed piggyback on top of the first line section. It can be a transmitter/receiver combination that determines the position of the bracket in relation to a reference system. There can be a marking, reflector or similar integrated into the bracket in order to position the bracket by means of an external positioning system. This tool can be used for assembly of interface brackets in the aircraft fuselage or when pre-assembling a module outside the aircraft fuselage (e.g. a triangle module or a floor module). Furthermore, it can be used for repairs while the aircraft is in-service.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-15. (canceled)

16. A holding bracket for a line assembly in an aircraft fuselage, the holding bracket comprising:
a receiving space; and
a support portion, wherein the support portion comprises:
a holding part at least partly surrounding the receiving space configured for receiving a line section of the assembly, and the holding part configured for holding the line section; and
a support part configured for fixedly attaching the holding part to a support,
wherein the holding part is attached to the support part via a movable attachment that is configured to provide a predetermined relative movement of the holding part in relation to the support part in an installed state of the line assembly.

17. The holding bracket according to claim 16, wherein the holding part of the support portion is configured to glide, rotate, or both in relation to the support part.

18. The holding bracket according to claim 16, wherein the support part is configured to be attached to a first line section, and the holding part is configured to receive a second line section being different than the first line section.

19. The holding bracket according to claim 16, wherein the support part and the holding part are provided as separate parts that are releasably connectable with each other.

20. The holding bracket according to claim 16, wherein, for an installation of a line, the holding part is configured to be fixed in relation to the support part in a predetermined installation position.

21. A modular line assembly for installation in an aircraft fuselage, the assembly comprising:
a first line section;
at least one second line section;
a set of first line brackets; and
a set of second line brackets;
wherein the first line brackets comprise a first receiving space designed for holding the first line section and a first support portion for attaching the first line brackets to a structural part of the fuselage;
wherein the second line brackets comprise a second receiving space configured for holding the at least one second line section and a second support portion for attaching the second line brackets to a support;
wherein the set of the second line brackets comprises at least one holding bracket according to claim 16; and
wherein the at least one second line section is attached to the first line section through a plurality of the second line brackets that are at least partly arranged at a distance to and are independent from the first line brackets.

22. The modular line assembly according to claim 21, wherein the second support portion is configured to move in relation to the first line section for compensating expansion, compression movements, or both of the at least one second line section.

23. The modular line assembly according to claim 21, wherein the second support portion is configured for attaching the second line brackets to the first line section.

24. The modular line assembly according to claim 21, wherein the second support portion is configured for attaching the second line brackets to a support structure.

25. The modular line assembly according to claim 21, wherein the at least one second line section comprises the same or higher flexibility than the first line section.

26. The modular line assembly according to claim 21, wherein the at least one second line section comprises at least one bend in an overlapping region with one of the first line brackets, another component, or both.

27. The modular line assembly according to claim 21, wherein the first line section comprises a vacuum pipe, and
wherein the at least one second line section comprises at least one water hose.

28. An aircraft comprising:
a fuselage having at least one from a group consisting of: a cargo space and a cabin space; and
an installation arrangement in the fuselage;
wherein the installation arrangement comprises at least one modular line assembly according to claim 21.

29. A method for installing a first line section and at least one second line section in a fuselage of an aircraft, comprising:
attaching a first line section having a first diameter to a structural part of the fuselage through first line brackets, which comprise a first receiving space for holding the first line section and a first support portion for attaching the first line brackets to the structural part; and
attaching at least one second line section having a second diameter to the first line section through second line brackets, which comprise a second receiving space for holding the at least one second line section and a second support portion for attaching the second line brackets to the first line section,
wherein at least one second line section comprises a higher flexibility than the first line section, and
wherein the at least one second line section is attached to the first line section through a plurality of second line brackets that are arranged at a distance to and are independent from the first line brackets.

30. A tool for mounting the holding bracket according to claim 16 to a mounting surface having an at least part-circular mounting contour, the tool comprising:
a first interface for releasably engaging with a connection interface of the holding bracket; and
a second interface for temporal engaging with a measuring device,
wherein in an engagement with the measuring device, the measuring device provides information about an angular relation of the holding bracket to the mounting surface.
